(19) United States
(12) Patent Application Publication
(10) Pub. No.: US 2011/0238897 A1
(43) Pub. Date: Sep. 29, 2011

(54) MEMORY SYSTEM, PERSONAL COMPUTER, AND METHOD OF CONTROLLING THE MEMORY SYSTEM

(75) Inventor: Takayuki ABE, Kanagawa (JP)

(73) Assignee: KABUSHIKI KAISHA TOSHIBA, Tokyo (JP)

(21) Appl. No.: 13/049,417

(22) Filed: Mar. 16, 2011

(30) Foreign Application Priority Data
Mar. 23, 2010 (JP) 2010-066768

(51) Int. Cl. G06F 12/02

(52) U.S. Cl. 711/103; 711/E12.008

(57) ABSTRACT

According to one embodiment, a memory system includes: a nonvolatile semiconductor memory including a plurality of normal blocks and at least one dummy block, each of the normal blocks being a unit of data erasing; a writing control unit that rewrites the dummy block the number of times equal to or larger than a maximum number of times among the numbers of times of rewriting of the normal blocks; a monitor unit that monitors a data erasing time or a data writing time of the dummy block; and a wear-leveling control unit that averages the numbers of times of rewriting of the normal blocks. The memory system determines, based on a monitor result of the monitor unit, possibility of continuation of the rewriting of the normal blocks.

### CROSS-REFERENCE TO RELATED APPLICATIONS

This application is based upon and claims the benefit of priority from the prior Japanese Patent Application No. 2010-066768, filed on Mar. 23, 2010; the entire contents of which are incorporated herein by reference.

### FIELD

Embodiments described herein relate generally to a memory system, a personal computer, and a method of controlling the memory system.

### BACKGROUND

A nonvolatile semiconductor memory such as a NAND flash memory has rewriting life. Therefore, concentration of writing and erasing on a specific writing and erasing unit (block) is prevented by wear leveling. For example, a block in which the number of times of erasing (the number of times of writing) exceeds a predetermined number and a block in which the number of times of erasing (the number of times of writing) is small are interchanged.

### BRIEF DESCRIPTION OF THE DRAWINGS

FIG. 1 is a block diagram of the configuration of a memory system according to a first embodiment of the present invention;

FIG. 2 is a diagram of distribution of the numbers of times of rewriting of normal blocks by wear leveling in the past;

FIG. 3 is a diagram of distribution of the numbers of times of rewriting of normal blocks by wear leveling in the first embodiment;

FIG. 4 is a block diagram of the configuration of a memory system according to a second embodiment of the present invention;

FIG. 5 is a diagram of distribution of the numbers of times of rewriting of normal blocks by wear leveling in the second embodiment;

FIG. 6 is a block diagram of the configuration of a memory system according to a third embodiment of the present invention;

FIG. 7 is a diagram of distribution of the numbers of times of rewriting of normal blocks by wear leveling in the third embodiment;

FIG. 8 is a perspective view of an example of a personal computer mounted with a solid state drive (SSD) according to a fourth embodiment; and

FIG. 9 is a diagram of a system configuration example of the personal computer mounted with the SSD according to the fourth embodiment.

### DETAILED DESCRIPTION

In general, according to one embodiment, a memory system includes: a nonvolatile semiconductor memory including a plurality of normal blocks and at least one dummy block, each of the normal blocks being a unit of data erasing; a writing control unit that rewrites the dummy block the number of times equal to or larger than a maximum number of times among the numbers of times of rewriting of the normal blocks; a monitor unit that monitors a data erasing time or a data writing time of the dummy block; and a wear-leveling control unit that averages the numbers of times of rewriting of the normal blocks. The memory system determines, based on a monitor result of the monitor unit, possibility of continuation of the rewriting among the normal blocks.

Recently, contrivance is made to uniformly distribute the numbers of times of rewriting among blocks to extend the life of an entire system. The number of times of writing and erasing is used for the control of the distribution of the numbers of times of rewriting.

However, tolerance of the number of times of writing and erasing fluctuates to some extent depending not only on a device type but also on a lot, an individual device, a block, or the like of the same type. It is conceivable that the number of times of writing and erasing set for each type in advance does not suit an actual situation. For example, a device is deteriorated earlier than an assumed number of times of writing and erasing in some cases and deteriorated later than the assumed number of times of writing and erasing in other cases. Therefore, it is difficult to perform highly accurate control.

The same problem occurs in a system that manages the number of times of rewriting for improvement of reliability other than the wear leveling. If the numbers of times of writing and erasing of all addresses are always monitored and determined in normal use, deterioration in performance of a nonvolatile semiconductor memory system may be caused.

Exemplary embodiments of a memory system, a personal computer, and a method of controlling the memory system will be explained below in detail with reference to the accompanying drawings. The present invention is not limited to the following embodiments.

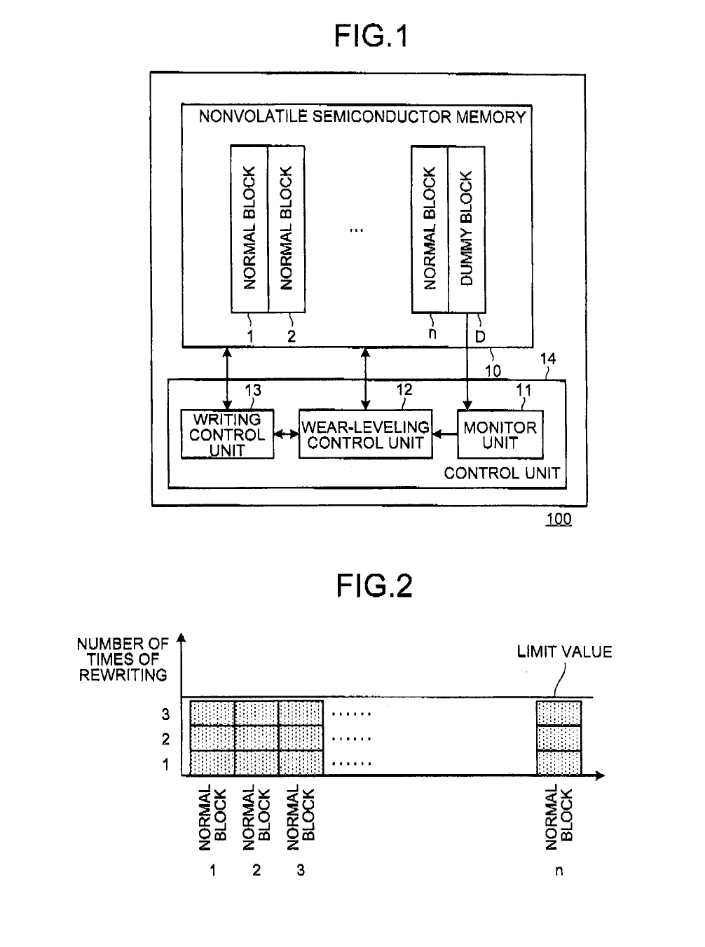

FIG. 1 is a block diagram of the configuration of a memory system 100 according to a first embodiment. The memory system 100 includes a nonvolatile semiconductor memory 10 such as a NAND flash memory and a control unit 14. The nonvolatile semiconductor memory 10 includes a plurality of arrayed normal blocks 1 to n, which are physical blocks as units of data erasing, and a dummy block D adjacent to the normal blocks 1 to n. The control unit 14 includes a monitor unit 11 that monitors a data erasing time and a writing time of the dummy block D, a wear-leveling control unit 12 that averages the numbers of times of rewriting among the normal blocks 1 to n, and a writing control unit 13 that rewrites the dummy block D the number of times equal to or larger than a maximum number of times among the numbers of times of rewriting of the normal blocks 1 to n.

In this embodiment, possibility of continuation of the rewriting of the normal blocks 1 to n is not determined according to a limit value of the number of times of rewriting set in advance for each type of a device. The dummy block D always written and erased the number of times equal to a maximum number of times among the numbers of times of writing and erasing of the normal blocks 1 to n is provided. Characteristics (specifically, a writing time and an erasing time) of the dummy block D are monitored to determine whether wear leveling is continued.

Wear leveling control includes dynamic wear leveling for recording the number of times of writing and erasing for each rewriting unit (block), selecting blocks in order from a block having a smallest number of times of rewriting when data update is performed, and executing erasing and writing and static wear leveling for interchanging a block not rewritten for a long time after data is stored therein once and rewritten a small number of times with a block rewritten a large number of times.

In the past, as shown in FIG. 2, the numbers of times of writing and erasing are leveled by wear leveling. When the numbers of times of writing and erasing reach a limit value of the number of times of rewriting set in advance for each type of a nonvolatile semiconductor memory, further rewriting of all blocks of the system memory is determined as impossible and the wear leveling ends.

However, actually, an allowed number of times varies for each individual nonvolatile semiconductor memory because of, for example, fluctuation in each lot or individual device due to a process or the like. Therefore, it is likely that an excess margin is allowed in the limit value.

In this embodiment, the dummy block D is provided in the nonvolatile semiconductor memory 10. The wear-leveling control unit 12 records and manages the numbers of times of rewriting of the normal blocks 1 to n. The writing control unit 13 always executes, based on the numbers of times of rewriting of the normal blocks 1 to n stored by the wear-leveling control unit 12, rewriting of the dummy block D the number of times equal to a maximum number among the numbers of times of the rewriting of the normal blocks 1 to n.

Specifically, if erasing of a specific physical block and writing in all physical pages included in the physical block are assumed to be rewriting performed once, the writing control unit 13 rewrites the dummy block D the number of times equal to a maximum number of times among the numbers of times of rewriting of the normal blocks 1 to n. As timing for rewriting of the dummy block D, it is conceivable to perform the rewriting when rewriting of a normal block rewritten a maximum number of times among the normal blocks 1 to n is performed. However, the rewriting is not always limited to this timing.

The monitor unit 11 monitors the last data erasing time or the last writing time of the dummy block D. It is conceivable to set an average of writing times of the physical pages in the dummy block D, a writing time of a physical page having largest aged deterioration in the dummy block D, a writing time of a predetermined physical page in the dummy block D, or the like as a writing time. However, the writing time is not limited to these writing times.

A data erasing time and a writing time increase or decrease according to fatigue due to rewriting of the physical blocks. Therefore, the monitor unit 11 determines a degree of fatigue of the dummy block D from a determination criterion such as a criterion that the last data erasing time of the dummy block D is larger than a predetermined first threshold or the last writing time of the dummy block is smaller than a predetermined second threshold.

The wear-leveling control unit 12 determines, based on a determination result of the degree of fatigue of the dummy block D given from the monitor unit 11, possibility of continuation of the rewriting of the normal blocks 1 to n and determines whether the wear leveling continues to be executed.

The monitor unit 11 may monitor only the last data erasing time or the last writing time of the dummy block D and notify the wear-leveling control unit 12 of information concerning the last data erasing time or the last writing time. The wear-leveling control unit 12 may determine a threshold of the last data erasing time or the last writing time of the dummy block D, i.e., determine a degree of fatigue of the dummy block D.

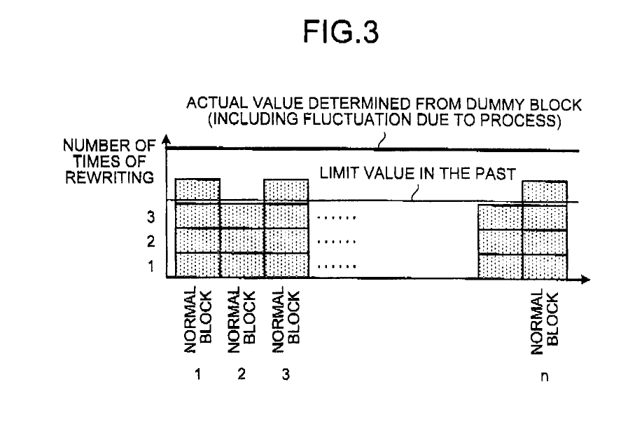

As explained above, in this embodiment, as shown in FIG. 3, possibility of continuation of the rewriting of the normal blocks is determined based on the writing and erasing characteristics of the dummy block D. Therefore, it is possible to perform wear leveling taking into account actual tolerance of the nonvolatile semiconductor memory. Consequently, when the limit value in the past is a value with an excess margin allowed taking into account, for example, fluctuation in a process or the like, it is possible to extend the life of the entire memory system.

If a function of warning, based on the determined degree of fatigue of the dummy block D, a user that the end of the life of the memory system is near is provided, when the life is exhausted before the limit value of the number of times of rewriting set in advance for each type, it is possible to cause the user to stop the use of the memory system. Therefore, it is possible to improve the reliability of the memory system.

To safely perform the life prediction warning and the determination based on a degree of fatigue of the dummy block D, a slight margin may be allowed in a maximum number of times of writing and erasing of the normal blocks 1 to n to execute writing and erasing of the dummy block D an excess number of times. In other words, the number of times of writing and erasing of the dummy block D may be set larger than a maximum number of times among the numbers of times of rewriting of the normal blocks.

For example, if writing and erasing of the dummy block D is performed a certain degree of number of times in a manufacturing stage, it is possible to provide a difference between the dummy block D and the normal blocks. Because an additional amount of the number of times can be freely set, the number of times is set variable according to a calculated reliability level. Consequently, in determining that the normal blocks 1 to n can be used if the dummy block D having a degree of fatigue equal to or larger than a maximum number of times among the numbers of times of rewriting of the normal blocks can be used, it is possible to perform adjustment for, for example, improving the reliability of the determination.

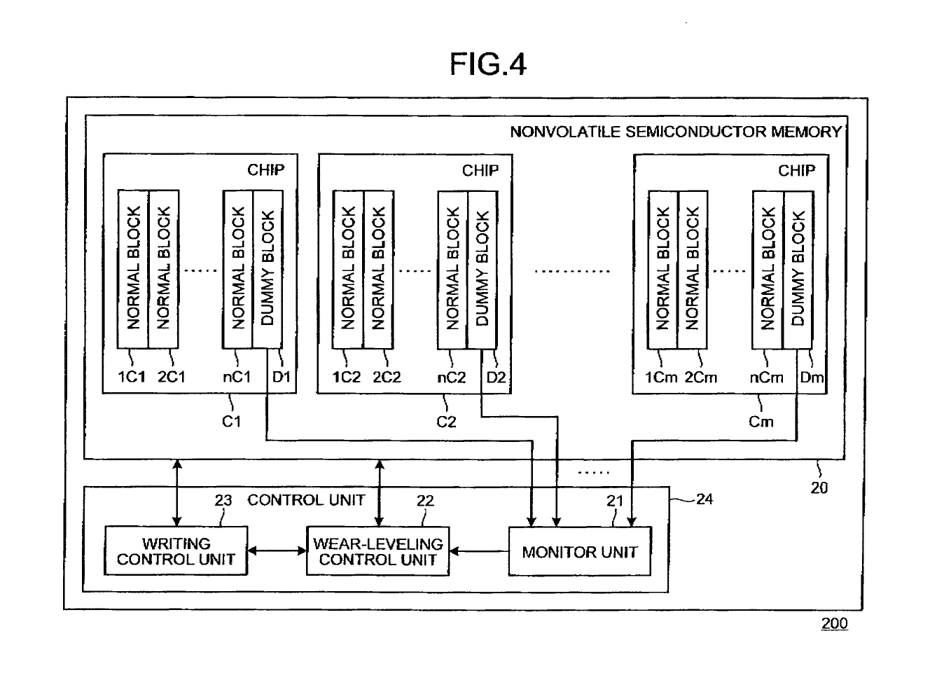

FIG. 4 is a block diagram of the configuration of a memory system 200 according to a second embodiment. The memory system 200 includes a nonvolatile semiconductor memory 20 such as a NAND flash memory including a plurality of chips C1 to Cm and a control unit 24. Each of the chips C1 to Cm includes a plurality of arrayed normal blocks, which are physical blocks as units of data erasing, and a dummy block adjacent to the normal blocks. For example, the chip C1 includes normal blocks 1C1 to nC1 and a dummy block D1. The same applies to the other chips C2 to Cm.

The control unit 24 includes a monitor unit 21 that monitors a data erasing time or a writing time of each of the dummy blocks D1 to Dm and a wear-leveling control unit 22 that averages the numbers of times of rewriting of the normal blocks 1C1 to nC1, 1C2 to nC2, . . . , and 1Cm to nCm. The control unit 24 further includes a writing control unit 23 that rewrites each of the dummy blocks D1 to Dm the number of times equal to or larger than a maximum number of times of each of the chips C1 to Cm among the numbers of times of rewriting of all the normal blocks in the chips C1 to Cm including the dummy blocks D1 to Dm.

In this embodiment, possibility of continuation of the rewriting of the normal blocks 1C1 to nC1, 1C2 to nC2, . . . , and 1Cm to nCm is not determined according to a limit value of the number of times of rewriting set in advance for each type of a device. The possibility of continuation of the rewriting is determined using the dummy blocks D1 to Dm. Specifically, each of the dummy blocks D1 to Dm written and erased the number of times equal to a maximum number of times of writing and erasing of the normal blocks in the chip is provided in each of the chips C1 to Cm and characteristics (specifically, a writing time and an erasing time) of the dummy block are monitored to determine whether wear leveling is continued for the normal blocks in the chip.

In the past, as shown in FIG. 2, differences among the chips are not distinguished. The numbers of times of writing and erasing are leveled by the wear leveling performed across the chip for the entire physical block. When the numbers of times of writing and erasing reach a limit value of the number of times of rewriting set in advance for the memory system, further rewriting of all blocks is determined as impossible and the wear leveling ends. However, actually, an allowed number of times varies for each chip because of, for example, fluctuation in a process. Therefore, it is likely that an excess margin is allowed in a specific chip.

In this embodiment, for example, the dummy books D1 to Dm are provided one by one in each of the chips C1 to Cm in the nonvolatile semiconductor memory 20. The wear-leveling control unit 22 records and manages the numbers of times of rewriting of the normal blocks 1C1 to nC1, 1C2 to nC2, . . . , and 1Cm to nCm. The writing control unit 23 always executes, based on these kinds of information, rewriting of each of the dummy blocks D1 to Dm of the chips C1 to Cm the number of times equal to a maximum number of times of each of the chips among the numbers of times of rewriting of the normal blocks included in the chips C1 to Cm.

Specifically, for example, the writing control unit 23 rewrites the dummy block D1 the number of times equal to a maximum number of times among the numbers of times of rewriting of the normal blocks 1C1 to nC1 included in the chip C1. The same applies to the dummy blocks D2 to Dm respectively included in the other chips C2 to Cm.

As timing for rewriting of each of the dummy blocks D1 to Dm, it is conceivable to perform the rewriting when rewriting of a normal block rewritten a maximum number of times among the normal blocks of the chip including the dummy block is performed. However, the rewriting does not always have to be limited to this timing.

The monitor unit 21 monitors the last data erasing time or the last writing time of each of the dummy blocks D1 to Dm. It is conceivable to set an average of writing times of physical pages in each of the dummy blocks D1 to Dm, a writing time of a physical page having largest aged deterioration in each of the dummy blocks D1 to DM, a writing time of a predetermined physical page in each of the dummy blocks D1 to Dm, or the like as a writing time. However, the writing time is not limited to these writing times.

The monitor unit 21 determines a degree of fatigue of each of the dummy blocks D1 to Dm from a determination criterion such as a criterion that the last data erasing time of each of the dummy blocks D1 to Dm is larger than a predetermined first threshold or the last writing time of each of the dummy blocks D1 to Dm is smaller than a predetermined second threshold.

The wear-leveling control unit 22 determines, based on a determination result of the degree of fatigue of each of the dummy blocks D1 to Dm given from the monitor unit 21, possibility of continuation of the rewriting of the chips C1 to Cm. Specifically, the wear-leveling control unit 22 regards the degree of fatigue of each of the dummy blocks D1 to Dm as a degree of fatigue of each of the chips C1 to Cm and continues the wear leveling among the normal blocks included in the chips in which continuation of the rewriting is regarded as possible without using the chips in which continuation of the rewriting is regarded as impossible.

The monitor unit 21 may monitor only the last data erasing time or the last writing time of each of the dummy blocks D1 to Dm and notify the wear-leveling control unit 22 of information concerning the last data erasing time or the last writing time. The wear-leveling control unit 22 may determine a threshold of the last data erasing time or the last writing time of each of the dummy blocks D1 to Dm, i.e., determine a degree of fatigue of each of the dummy blocks D1 to Dm.

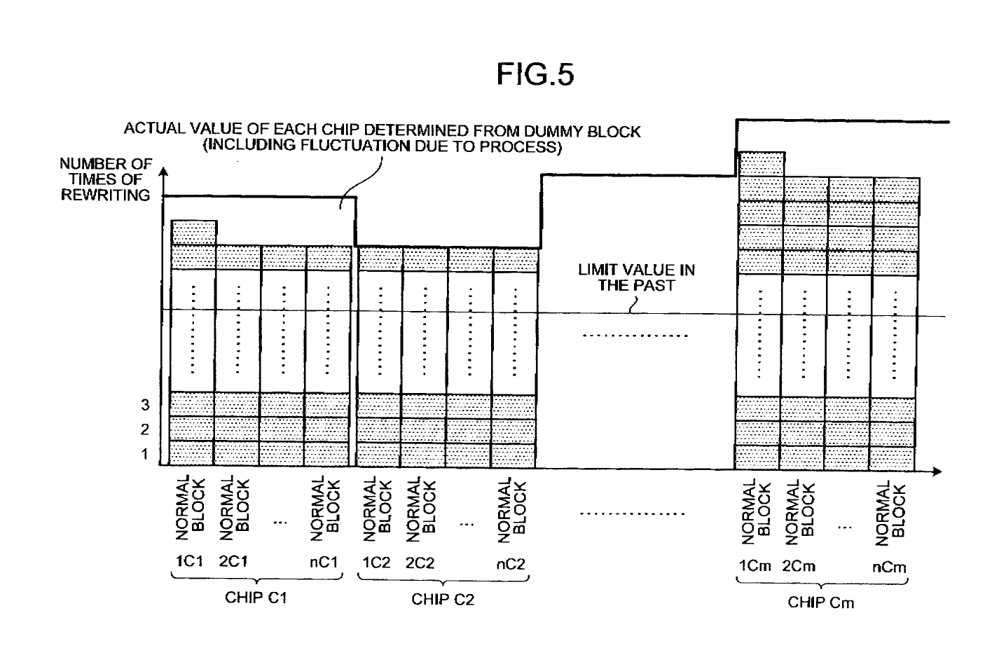

As explained above, in this embodiment, as shown in FIG. 5, possibility of continuation of the rewriting of each of the chips C1 to Cm is determined based on the writing and erasing characteristics of each of the dummy blocks D1 to Dm. Therefore, it is possible to perform wear leveling taking into account a difference in actual tolerance due to fluctuation in a process or the like among the chips C1 to Cm mounted on the nonvolatile semiconductor memory 20. Consequently, when the limit value in the past is a value with an excess margin allowed for the chips, it is possible to extend the life of the entire memory system.

It is also possible to provide a function of warning, based on the determined degrees of fatigue of the dummy blocks D1 to Dm, a user that the end of the life of the memory system 200 is near on the occasion that a degree of fatigue of the dummy block (i.e., the chip including the dummy block) having the longest life reaches a limit. This makes it possible to cause the user to stop the use of the memory system 200.

As explained above, according to this embodiment, a chip likely to exhaust the life before a limit value of the number of times of rewriting set in advance can be excluded from a target of the wear leveling. Therefore, it is possible to improve the reliability of the memory system in any event.

To safely perform the life prediction warning and the determination based on degrees of fatigue of the dummy blocks D1 to Dm, as in the first embodiment, a slight margin may be allowed in a maximum number of times of writing and erasing of the normal blocks 1C1 to nC1, 1C2 to nC2, . . . , and 1Cm to nCm to execute writing and erasing of the dummy blocks D1 to Dm excess numbers of times. In other words, the numbers of times of writing and erasing of the dummy blocks D1 to Dm may be set larger than a maximum number of times among the numbers of times of rewriting of the normal blocks 1C1 to nC1, 1C2 to nC2, . . . , and 1Cm to nCm.

For example, if writing and erasing of the dummy blocks D1 to Dm is performed a certain degree of number of times in a manufacturing stage, it is possible to provide a difference between the dummy blocks D1 to Dm and the normal blocks 1C1 to nC1, 1C2 to nC2, . . . , and 1Cm to nCm. Because an additional amount of the number of times can be freely set, the number of times is set variable according to a calculated reliability level.

Consequently, for each of the chips, a degree of fatigue equal to or larger than a maximum number of times among the numbers of times of rewriting of the normal blocks is given to the dummy block of the chip. Therefore, in determining that the chip can be used if the dummy block can be used, it is possible to perform adjustment for, for example, improving the reliability of the determination.

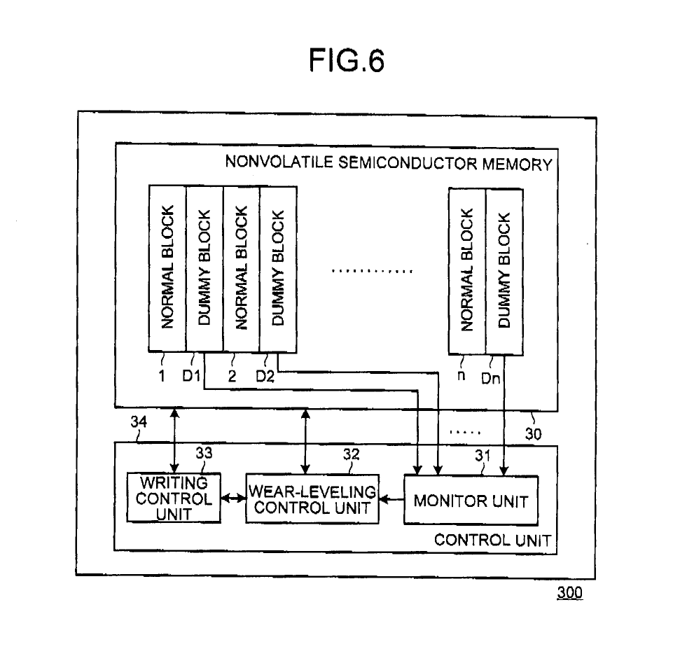

FIG. 6 is a block diagram of the configuration of a memory system 300 according to a third embodiment. The memory system 300 includes a nonvolatile semiconductor memory 30 such as a NAND flash memory and a control unit 34. The nonvolatile semiconductor memory 30 includes a plurality of sets of normal blocks, which are physical blocks as units of data erasing, and dummy blocks adjacent to the normal blocks. Specifically, dummy blocks D1, D2, . . . , and Dn are respectively arranged adjacent to a normal block 1, a normal block 2, . . . , and a normal block n.

The control unit 34 includes a monitor unit 31 that monitors data erasing times or writing times of the dummy blacks 1 to Dn, a wear-leveling control unit 32 that averages the numbers of times of rewriting among the normal blocks 1 to n, and a writing control unit 33 that rewrites each of the dummy blocks D1 to Dn the number of times equal to or larger than the number of times of rewriting of each of the normal blocks 1 to n.

In this embodiment, possibility of continuation of the rewriting of the normal blocks 1 to n is not determined according to a limit value of the number of times of rewriting set in advance for each type of a device. Each of the dummy blocks D1 to Dn always written and erased the number of times same as the number of times of writing and erasing of each of the normal blocks 1 to n is provided. Characteristics (specifically, a writing time and an erasing time) of the dummy block are monitored to determine whether the normal block is set as a target of the wear leveling.

In the past, as shown in FIG. 2, the numbers of times of writing and erasing are leveled by wear leveling. When the numbers of times of writing and erasing reach a limit value of the number of times of rewriting set in advance for each type of a device, further rewriting of all blocks of the system memory is determined as impossible and the wear leveling ends. However, actually, an allowed number of times varies for each of the normal blocks because of fluctuation in a process. Therefore, it is likely that an excess margin is allowed concerning a specific normal block.

In this embodiment, one dummy block is provided for each one normal block in the nonvolatile semiconductor memory 30. The wear-leveling control unit 32 records and manages the numbers of times of rewriting of the normal blocks 1 to n. The writing control unit 33 always executes, based on these kinds of information, rewriting on the dummy blocks D1 to Dn corresponding to the normal blocks 1 to n the numbers of times same as the numbers of times of rewriting of the normal blocks 1 to n.

As timing for rewriting of each of the dummy blocks D1 to Dn, it is conceivable to perform the rewriting, for example, when rewriting of each of the normal blocks 1 to n corresponding thereto is performed. However, the rewriting does not always have to be limited to this timing.

The monitor unit 31 monitors the last data erasing time or the last writing time of each of the dummy blocks D1 to Dn. A writing time of each of the dummy blocks D1 to Dn can be defined in the same manner as the second embodiment.

The monitor unit 31 determines a degree of fatigue of each of the dummy blocks D1 to Dn from a determination criterion such as a criterion that the last data erasing time of each of the dummy blocks D1 to Dn is larger than a predetermined first threshold or the last writing time of each of the dummy blocks D1 to Dn is smaller than a predetermined second threshold.

The wear-leveling control unit 32 determines, based on a determination result of the degree of fatigue of each of the dummy blocks D1 to Dn given from the monitor unit 31, possibility of continuation of the rewriting of the normal blocks 1 to n. Specifically, the wear-leveling control unit 32 regards the degree of fatigue of each of the dummy blocks D1 to Dn as a degree of fatigue of each of the normal blocks 1 to n and continues the wear leveling among the normal blocks in which continuation of the rewriting is regarded as possible without using the normal blocks in which continuation of the rewriting is regarded as impossible.

The monitor unit 31 may monitor the last data erasing time or the last writing time of each of the dummy blocks D1 to Dn and notify the wear-leveling control unit 32 of information concerning the last data erasing time or the last writing time. The wear-leveling control unit 32 may determine a threshold of the last data erasing time or the last writing time of each of the dummy blocks D1 to Dn, i.e., determine a degree of fatigue of each of the dummy blocks D1 to Dn.

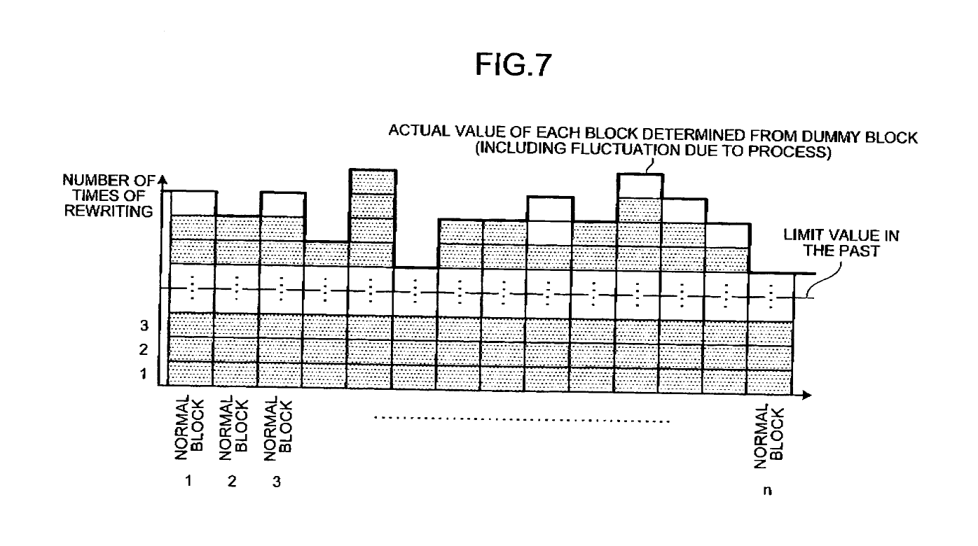

As explained above, in this embodiment, as shown in FIG. 7, a limit value of the number of times of rewriting is set for each of the normal blocks 1 to n and possibility of continuation of the rewriting of each of the normal blocks 1 to n is determined based on the writing and erasing characteristics of the dummy blocks D1 to Dn. Therefore, it is possible to perform wear leveling taking into account a difference in actual tolerance due to fluctuation in a process or the like among the blocks in the nonvolatile semiconductor memory 30. In other words, it is possible to take into account a difference in tolerance among physical blocks in a chip finer than the difference in tolerance among chips taken into account in the second embodiment.

Consequently, when the limit value in the past is a value with an excessive margin allowed for the normal blocks, the memory system can be continuously used based on a degree of fatigue of a dummy block having the longest life among the dummy blocks D1 to Dn determined as explained above. Therefore, it is possible to extend the life of the entire memory system.

To safely perform the determination based on degrees of fatigue of the dummy blocks D1 to Dn, as in the second embodiment, a slight margin may be allowed in the number of times of writing and erasing of the normal blocks 1 to n to execute writing and erasing of the dummy blocks D1 to Dn excess numbers of times.

In other words, the numbers of times of writing and erasing of the dummy blocks D1 to Dn may be set larger than the number of times of rewriting of each of the normal blocks 1 to n. Consequently, in determining that the normal blocks 1 to n can be used if each of the dummy blocks D1 to Dn having a degree of fatigue equal to or larger than the number of times of rewriting of each of the normal blocks 1 to n can be used, it is possible to perform adjustment for, for example, improving the reliability of the determination.

In the embodiments explained above, one dummy block is provided for each one normal block. However, a large number of normal blocks may be grouped into a plurality of areas and one dummy block may be provided for a plurality of normal blocks belonging to each of the areas, i.e., one dummy block may be provided for each of the areas.

In that case, each of the dummy blocks is constantly rewritten the number of times equal to or larger than a maximum number of times among the numbers of times of rewriting of all the normal blocks in the area in which the dummy block is provided. The monitor unit determines a degree of fatigue of each of the dummy blocks from a determination criterion that, for example, the last data erasing time or the last writing time of each of the dummy blocks is larger or smaller than a predetermined threshold.

The wear-leveling control unit determines, based on a determination result of a degree of fatigue of each of the dummy blocks given from the monitor unit, possibility of continuation of the rewriting of the area in which each of the dummy blocks is provided. Specifically, the wear-leveling control unit regards the degree of fatigue of each of the dummy blocks as a degree of fatigue of each of the areas and continues the wear leveling among the normal blocks included in the areas in which continuation of the rewriting is regarded as possible without using the normal blocks in the areas in which continuation of the rewriting is regarded as impossible. Otherwise, this embodiment is the same as the embodiments explained above.

As explained above, in various mechanisms for improvement of reliability such as wear leveling, the dummy block is used instead of the number of times of rewriting as a determination criterion, a load of writing and erasing equal to or larger than the number of times of writing and erasing of the normal block at that point is given to the dummy block every time the writing or erasing is performed, and a characteristic of the dummy block, for example, an erasing characteristic (equivalent to an erasing time) or a writing characteristic (equivalent to a writing time) is monitored.

Consequently, it is possible to perform highly accurate management adapted to a degree of deterioration in each individual device or block that depends on fluctuation among lots, individual devices, chips, or blocks due to a process or the like. It is possible to perform determination of reliability and prediction of life close to actual values without causing an excess margin. Therefore, it is possible to improve reliability of the entire memory system.

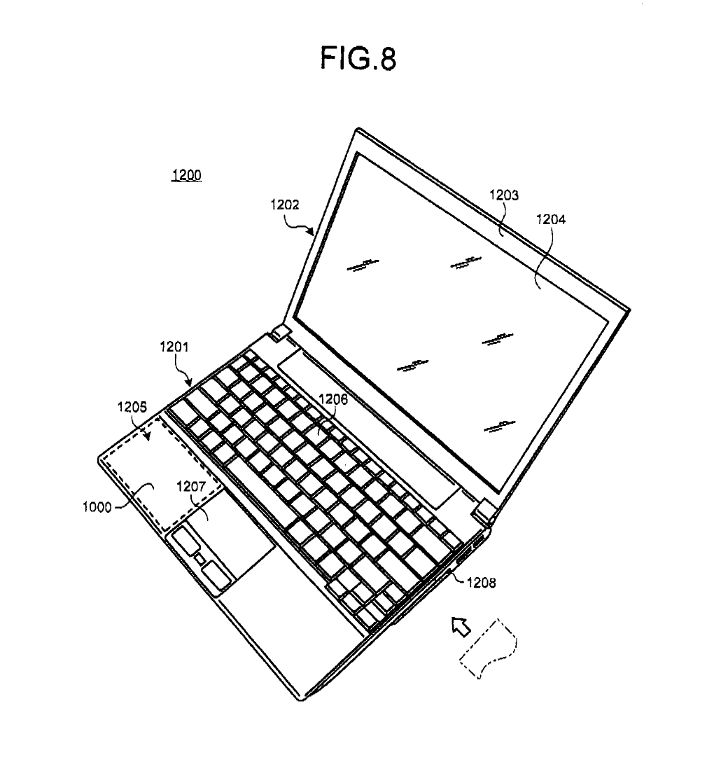

FIG. 8 is a perspective view of an example of a personal computer 1200 mounted with a solid state drive (SSD) 1000 according to a fourth embodiment. The SSD 1000 is, for example, the memory system 100, 200, or 300 explained in the first to third embodiment.

The personal computer 1200 includes a main body 1201 and a display unit 1202. The display unit 1202 includes a display housing 1203 and a display device 1204 housed in the display housing 1203.

The main body 1201 includes a housing 1205, a keyboard 1206, and a touch pad 1207, which is a pointing device. A main circuit substrate, an optical disk device (ODD) unit, a card slot, an SSD 1000, and the like are housed in the housing 1205.

The card slot is provided adjacent to a peripheral wall of the housing 1205. An opening 1208 opposed to the card slot is provided in the peripheral wall. A user can insert an additional device into the card slot from the outside of the housing 1205 through the opening 1208.

The SSD 1000 may be used in a state in which the SSD 1000 is mounted on the inside of the personal computer 1200 as a replacement for the HDD in the past or may be used as an additional device in a state in which the SSD 1000 is inserted in the card slot provided in the personal computer 1200.

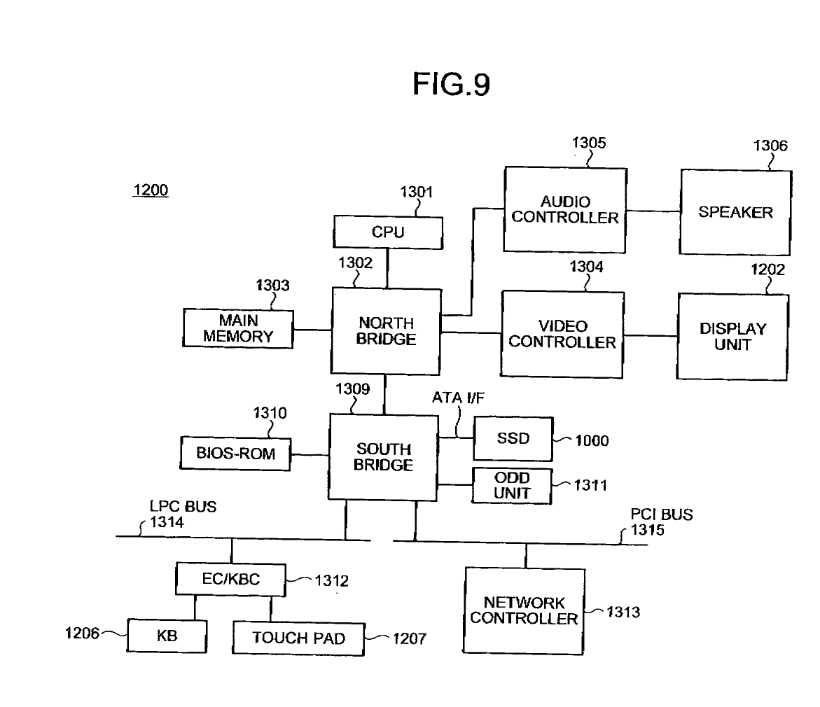

FIG. 9 is a diagram of a system configuration example of the personal computer mounted with the SSD. The personal computer 1200 includes a CPU 1301, a north bridge 1302, a main memory 1303, a video controller 1304, an audio controller 1305, a south bridge 1309, a BIOS-ROM 1310, an SSD 1000, an ODD unit 1311, an embedded controller/keyboard controller IC (EC/KBC) 1312, and a network controller 1313.

The CPU 1301 is a processor provided to control the operation of the personal computer 1200. The CPU 1301 executes an operating system (OS) loaded from the SSD 1000 to the main memory 1303. Further, when the ODD unit 1311 enables execution of at least one of readout processing and writing processing on an inserted optical disk, the CPU 1301 executes the processing.

The CPU 1301 also executes a system basic input output system (BIOS) stored in the BIOS-ROM 1310. The system BIOS is a computer program for hardware control in the personal computer 1200.

The north bridge 1302 is a bridge device that connects a local bus of the CPU 1301 and the south bridge 1309. A memory controller that controls access to the main memory 1303 is also incorporated in the north bridge 1302.

The north bridge 1302 also has a function of executing communication with the video controller 1304 and communication with the audio controller 1305 via an accelerated graphics port (AGP) bus or the like.

The main memory 1303 temporarily stores a computer program and data and functions as a work area for the CPU 1301. The main memory 1303 includes, for example, a DRAM.

The video controller 1304 is a video reproduction controller that controls the display unit 1202 used as a display monitor of the personal computer 1200.

The audio controller 1305 is an audio reproduction controller that controls a speaker 1306 of the personal computer 1200.

The south bridge 1309 controls devices on a low pin count (LPC) bus 1314 and devices on a peripheral component interconnect (PCI) bus 1315. The south bridge 1309 controls the SSD 1000, which is a storage device that stores various kinds of software and data, via an ATA interface.

The personal computer 1200 performs access to the SSD 1000 in sector unit. A writing command, a readout command, a flash command, and the like are input to the SSD 1000 via the ATA interface.

The south bridge 1309 also has a function of controlling access to the BIOS-ROM 1310 and the ODD unit 1311.

The EC/KBC 1312 is a one-chip microcomputer in which an embedded controller for power management and a keyboard controller for controlling the keyboard (DB) 1206 and the touch pad 1207 are integrated.

The EC/KBC 1312 has a function of turning on and off a power supply for the personal computer 1200 according to operation of a power button by a user. The network controller 1313 is a communication device that executes communication with an external network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a nonvolatile semiconductor memory including a plurality of normal blocks and at least one dummy block, each of the normal blocks being a unit of data erasing;
a writing control unit that rewrites the dummy block a number of times equal to or larger than a maximum number of times among numbers of times of rewriting of the normal blocks;
a monitor unit that monitors a data erasing time or a data writing time of the dummy block; and
a wear-leveling control unit that averages the numbers of times of rewriting of the normal blocks, wherein
the memory system determines, based on a monitor result of the monitor unit, possibility of continuation of the rewriting of the normal blocks.

2. The memory system according to claim 1, wherein
the nonvolatile semiconductor memory includes a plurality of chips including the normal blocks and includes the dummy block in each of the chips, and
the writing control unit rewrites the dummy block a number of times equal to or larger than a maximum number of times among number of times of rewriting of all the normal blocks in the chip including the dummy block.

3. The memory system according to claim 1, wherein
the nonvolatile semiconductor memory includes a plurality of areas including the normal blocks and includes the dummy block in each of the areas, and
the writing control unit rewrites the dummy block a number of times equal to or larger than a maximum number of times among number of times of rewriting of all the normal blocks in the area including the dummy block.

4. A memory system comprising:
a nonvolatile semiconductor memory including a plurality of sets of a normal block, which is a unit of data erasing, and a dummy block;
a writing control unit that rewrites each of the dummy blocks a number of times equal to or larger than a number of times of rewriting of each of the normal blocks;
a monitor unit that monitors data erasing times or data writing times of the dummy blocks; and
a wear-leveling control unit that averages the numbers of times of rewriting of the normal blocks, wherein
the memory system determines, based on a monitor result of the monitor unit, possibility of continuation of the rewriting of the normal blocks.

5. The memory system according to claim 1, wherein the memory system determines that the continuation of the rewriting of the normal blocks is impossible when the erasing time is larger than a first threshold in the monitor result of the monitor unit.

6. The memory system according to claim 2, wherein the memory system determines that the continuation of the rewriting of the normal blocks is impossible when the erasing time is larger than a first threshold in the monitor result of the monitor unit.

7. The memory system according to claim 3, wherein the memory system determines that the continuation of the rewriting of the normal blocks is impossible when the erasing time is larger than a first threshold in the monitor result of the monitor unit.

8. The memory system according to claim 4, wherein the memory system determines that the continuation of the rewriting of the normal blocks is impossible when the erasing time is larger than a first threshold in the monitor result of the monitor unit.

9. The memory system according to claim 1, wherein the memory system determines that the continuation of the rewriting of the normal blocks is impossible when the writing time is smaller than a second threshold in the monitor result of the monitor unit.

10. The memory system according to claim 2, wherein the memory system determines that the continuation of the rewriting of the normal blocks is impossible when the writing time is smaller than a second threshold in the monitor result of the monitor unit.

11. The memory system according to claim 3, wherein the memory system determines that the continuation of the rewriting of the normal blocks is impossible when the writing time is smaller than a second threshold in the monitor result of the monitor unit.

12. The memory system according to claim 4, wherein the memory system determines that the continuation of the rewriting of the normal blocks is impossible when the writing time is smaller than a second threshold in the monitor result of the monitor unit.

13. The memory system according to claim 1, wherein the writing control unit rewrites the dummy block a certain degree of number of times in a manufacturing stage.

14. The memory system according to claim 2, wherein the writing control unit rewrites the dummy block a certain degree of number of times in a manufacturing stage.

15. The memory system according to claim 3, wherein the writing control unit rewrites the dummy block a certain degree of number of times in a manufacturing stage.

16. The memory system according to claim 4, wherein the writing control unit rewrites the dummy block a certain degree of number of times in a manufacturing stage.

17. A method of controlling a memory system including a nonvolatile semiconductor memory having a plurality of normal blocks and at least one dummy block, each of the normal blocks being a unit of data erasing, the method comprising:
rewriting the dummy block a number of times equal to or larger than a maximum number of times among numbers of times of rewriting of the normal blocks;
monitoring a data erasing time or a data writing time of the dummy block;
averaging the numbers of times of rewriting of the normal blocks; and
determining, based on a monitor result of the monitor unit, possibility of continuation of the rewriting of the normal blocks.

18. The method of controlling the memory system according to claim 17, wherein
the nonvolatile semiconductor memory includes a plurality of chips including the normal blocks and includes the dummy block in each of the chips, and
the method further comprises rewriting the dummy block a number of times equal to or larger than a maximum number of times among number of times of rewriting of all the normal blocks in the chip including the dummy block.

19. The method of controlling the memory system according to claim 17, wherein
the nonvolatile semiconductor memory includes a plurality of areas including the normal blocks and includes the dummy block in each of the areas, and
the method further comprises rewriting the dummy block a number of times equal to or larger than a maximum number of times among number of times of rewriting of all the normal blocks in the area including the dummy block.

20. The method of controlling the memory system according to claim 17, further comprising rewriting the dummy block a certain degree of number of times in a manufacturing stage.
